(19) United States
(12) Patent Application Publication
(10) Pub. No.: US 2004/0197732 A1
(43) Pub. Date: Oct. 7, 2004

(54) Suction device

(76) Inventor: Russell Sullman, London (GB)

Correspondence Address: Carl E Moore Jr, Marshall Gerstein & Borun, Sears Tower Suite 6300, 233 South Wacker Drive, Chicago, IL, 60606-6357, US

(21) Appl. No.: 10/475,252

(22) PCT Filed: Apr. 16, 2002
(86) PCT No.: PCT/GB02/01768

(30) Foreign Application Priority Data
Apr. 18, 2001 (GB) 0109560.3

(51) Int. Cl. A61C 17/06

(52) U.S. Cl. 433/94

(57) ABSTRACT

A suction device for use in medical dental and veterinary operations comprises a body (X) incorporating a clamp (D) for detachably securing the device to a patient to enable the device to be self-supporting. For use in dental operations the clamp (D) may be designed to be detachably secured to a patient's tooth (A). A suction nozzle (N) can be inserted into the body (X) and an external suction tube (T) can also be detachably inserted into the body (X) to enable suction to be applied at the tip of the nozzle (N). A loop (L) can be provided to enable the device to be sutured to a suitable point either inside or outside the mouth of a patient to provide added security in the event of the device becoming loose during operational use. The device may be provided with an applicator, which can be of a conventional kind.

### TECHNICAL FIELD

This invention relates to suction devices for use in medical, dental and veterinary operations.

### BACKGROUND

Surgeons, and especially dental surgeons, sometimes have to work without the help of a nursing assistant. It therefore becomes necessary that, in addition to performing the surgical procedure, they themselves simultaneously have to provide adequate suction to the region subject to the procedure. This puts greater stress on the surgeon and may make it more difficult to provide the desired treatment Also, in the case of a small operating field space is limited and work has to be frequently stopped to allow adequate clearance of fluid and debris. It is therefore an object of the invention to provide a device by which the above problems are eliminated or at least mitigated.

### SUMMARY OF THE INVENTION

According to the invention there is provided a suction device for use in medical, dental and veterinary operations comprises a clamp for detachably securing the device to the patient being operated on to enable the device to be self-supporting and securing means for securing a suction nozzle to the device.

For use in dental operations preferably the clamp is arranged for detachably securing the device to one or more of a patient's teeth. The device may be supplied with a means by which it may be reversibly secured to soft tissues or some point outside of the body as a means of security should the device work loose during function. This would prevent the device from being swallowed.

Although the device may be optionally provided with an integral nozzle or suction tube, or same in detachable form, the device primarily is for holding/securing suction systems separate from the device in position during function.

Where the device is provided with an integral or detachable suction tube, the tube can have a connector to allow for attachment to separate suction systems at one end and a nozzle at the other.

In preferred embodiments of the invention, one or more support pylons or other fixing or clamping means can be provided for securing the device to more than one tooth and for enabling the device to be held clear of an operating region in a patient's mouth as well as to give additional support/stability to the suction tube holding component of the device.

A plurality of suction nozzles may be provided which are all attached to a common suction tube and each nozzle may be independently moveable to a desired position. Alternatively the nozzles may be provided along the length of a common suction tube.

The suction nozzle may be part of a multi-lumen arrangement of water and/or air supply tubes.

### BRIEF DESCRIPTION OF THE DRAWINGS

By way of example embodiments of this invention will now be described with reference to the accompanying drawings of which:

FIG. 1 illustrates a device for use in dental operations embodying the invention,

FIG. 2 illustrates a device in accordance with an alternative embodiment of the invention,

FIG. 3 shows a single suction tube terminating in a plurality of suction nozzles,

FIG. 4 shows at (A) and (B) two alternative positions for a dual suction nozzle arrangement,

FIG. 5 shows at (A) and (B) two examples of a single suction tube arranged with a plurality of separate openings acting as individual suction nozzles,

FIGS. 6(A) and 6(B) show means of attachment of a suction nozzle to a clamp, which is shown at FIG. 6(c), and

FIGS. 7, 8 and 9 show further examples of the invention for dental use.

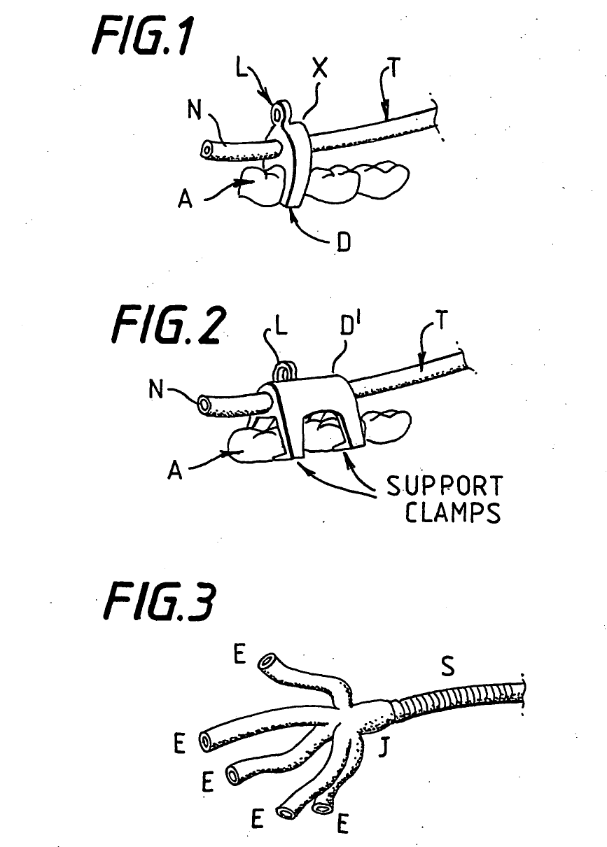

Referring now to FIG. 1 there is shown therein a suction device for use in dental operations. The device comprises a body (X) integral with a clamp D which is mounted on a tooth A. The outer surface of clamp D is rounded in shape so as to protect the soft tissues of the mouth from damage. The inner surface of clamp D is shaped to conform to the shape of a tooth such as tooth A. Due to the bulbous nature of tooth A clamp D remains firmly attached in all three planes. A suction tube with nozzle N is inserted through a bore in body (X) that keeps a suction tube T secured during operational use. When the clamp is removed, the tube can then be removed from the device. The device may also be provided with tube T or part of it being incorporated into the structure of the device.

Also integral with body (X) is a ring or loop L to which a suture or other holding means may be attached as a safety measure so as to make it possible for the device to be recovered if it accidentally works loose in the mouth. One or more additional supportive anchorage components or non-fixing elements could be attached to the device either as a means of further support, e.g. by attachment to more than one tooth (see FIG. 2) or as a further security against detachment of the device from the tooth during operation.

FIG. 2 shows a device that is also for use in dental surgery. It is generally similar in function to the device shown in FIG. 1 and like parts have like references. The principal difference in the device shown in FIG. 2 in comparison with the device shown in FIG. 1 is that in FIG. 2 clamp D′ is of a more robust design and is arranged with two pairs of jaws which clamp onto two respective adjacent teeth rather than having a single pair of jaws as shown in FIG. 1.

The device may be provided with means to grip a variety of arrangements of suction tube or tubes for the provision of either compressed air and/or water.

FIG. 3 illustrates in perspective a central lumen core J attached to a suction tube S. Lumen core J has integral adjustable extension tubes E attached to it. Each extension tube E terminates in a suction nozzle and the suction nozzles may be placed at differing locations as the need arises. The nozzles may be either loose or rigid, in the latter instance allowing placement as required at a particular location.

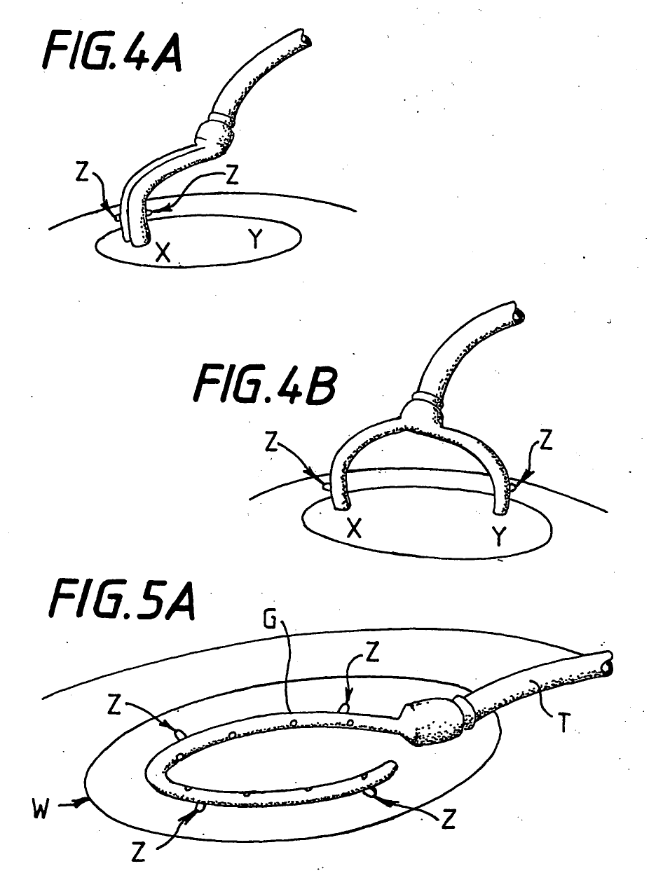

The provision of more than one suction nozzle enables suction to be maintained during a procedure without affecting the suction at a particular location. FIG. 4 shows an example of this possibility at (A) and (B) respectively. A suction tube S has two nozzles which as shown at (A) are both positioned at a location X. If required at a particular stage in a procedure one of the nozzles may remain at location X while the other nozzle is moved to another location Y. In this way suction can be maintained at location X without interruption and also applied simultaneously elsewhere at location Y. Loops Z can be provided for both nozzles for reversibly holding the nozzles at their required locations, for example around the perimeter of a wound W.

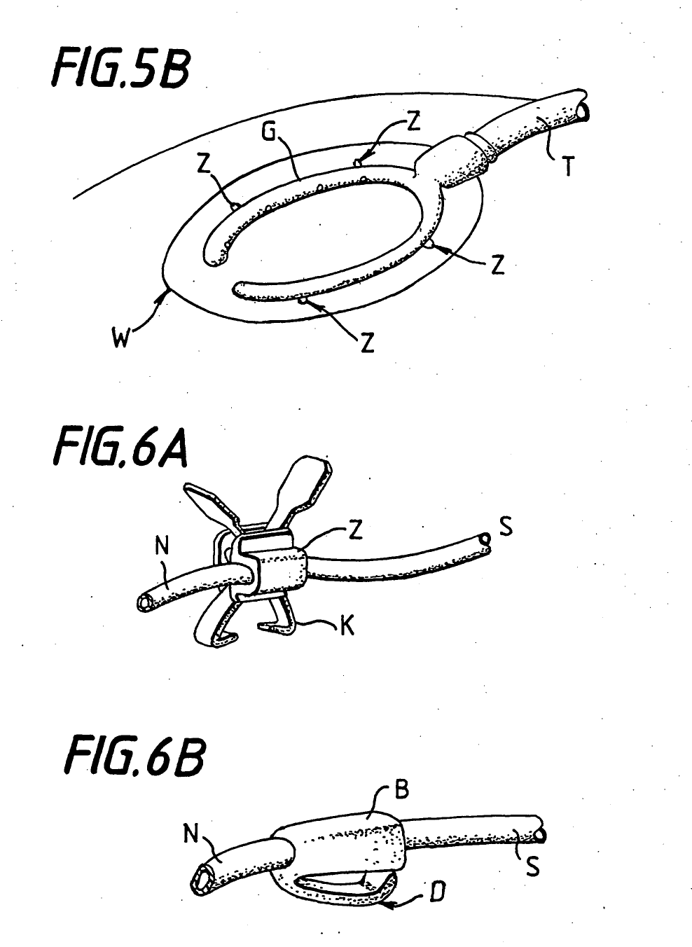

FIG. 5(A) and FIG. 5(B) show two alternative examples of a single suction tube T terminating in a multi-nozzle termination element G having a plurality of nozzles which can be placed around part or all of a wound area W. Element G can be rigid or flexible and may include loops Z by which it can be held in place by suturing, for example.

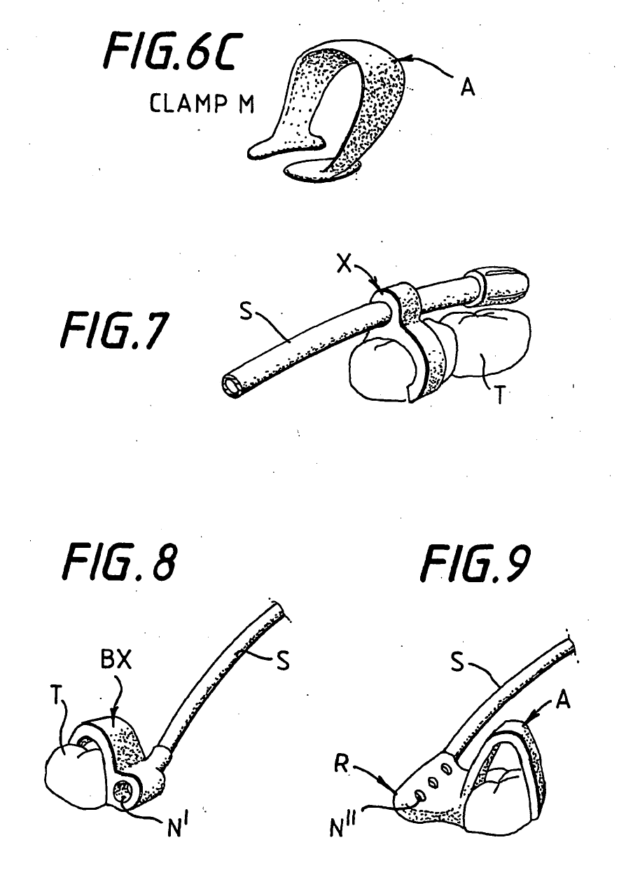

In FIG. 6(A) and FIG. 6(B) there are shown two examples of means of securing the device to a rubber dam clamp M. which is shown at FIG. 6(c). FIG. 6(A) illustrates the use of a rigid clip K for attachment of a suction nozzle N supplied from a separate suction tube S to clamp M. FIG. 6(B) illustrates the use of a flexible clip D for attachment of a suction nozzle N, likewise supplied with suction through a tube S, to clamp M. With the suction tube 5 in both examples being held by insertion through the body of the device B or Z, or optionally being supplied as an integral part of the device so that clip D or clip K may allow means of suction to be secured, via the device, to the rubber damp clamp M at point A.

FIG. 7 shows how a saliva ejector S (a form of suction tube currently in general dental use) can be held by the device X to tooth T, thereby illustrating use of the device with existing types of suction tube.

In FIG. 8 a suction device is shown comprising a tooth clamp BX and a separate suction tube S which is inserted into a nozzle N′ which is integral with clamp BX.

In yet another embodiment as shown in FIG. 9 a clamp A is provided with a plurality of suction nozzles or openings N″ arranged within a tissue retractor R integral with clamp A. A suction tube S is coupled to or inserted into retractor R so that suction can be applied to openings N″.

All or some of the components of the device may be disposable or else re-usable and can be made of any suitable material, for example plastic or metal. The individual components of the device may be integral with each other or else detachable.

A device embodying the invention can be used in general and in hospital surgery, both medical and dental, to keep the field of operation clear without having a nurse constantly on suction duty. This allows a greater area of working for the operating surgeon and less interruption in his work for enabling suction of unwanted debris to take place. It can then be possible for the surgeon to concentrate more on the procedure whilst the suction tube is held in an optimal position by the device without outside assistance.

1. A suction device for use in medical, dental and veterinary operations on a patient, the suction device being characterised by the provision of a clamp for detachably securing the device to the patient being operated on to enable the device to be self-supporting, and securing means for securing a suction nozzle to the device.

2. A suction device as claimed in claim 1, characterised in that the clamp is arranged for detachably securing the device to one or more of a patient's teeth.

3. A suction device as claimed in claim 1, characterised in that the clamp is arranged for detachably securing the device to soft tissue.

4. A suction device as claimed in claim 1, characterised in that the securing means enables a suction nozzle to be detachably secured to the device.

5. A suction device as claimed in claim 1, characterised in that the securing means is integral with the suction nozzle.

6. A suction device as claimed in claim 1, further including a suction nozzle, characterised in that the suction nozzle is provided with means for securing a suction tube to the suction nozzle.

7. A suction device as claimed in claim 6 characterised by the inclusion of a suction tube connected at one end to the suction nozzle and having a connector at its other end for connection to an extraction pump.

8. A suction device as claimed in claim 1, further including a suction nozzle, characterised in that means are provided for enabling the suction nozzle to be oriented in a plurality of different directions.

9. A suction device as claimed in claim 1, characterised by the inclusion of safety attachment means for enabling the device to be attached to a patient.

10. A suction device as claimed in claim 9 characterised in that the safety attachment means is arranged to be attached to the patient outside the patient's mouth.

11. A suction device as claimed in claim 1, characterised by the inclusion of one or more support means for enabling the device to be secured to one or more further teeth.

12. A suction device as claimed in claim 1, characterised in that a plurality of suction nozzles are provided which are all attached to a common suction tube.

13. A suction device as claimed in claim 12, characterised in that the plurality of suction nozzles are provided contained within a housing having means for securing a suction tube thereto.

14. A suction device as claimed in claim 12 or claim 13, characterised in that each nozzle is independently movable to a desired position.

15. A suction device as claimed in claim 12, characterised in that the nozzles are provided along the length of a common suction tube.

16. A suction device as claimed in claim 1, further including a suction nozzle, and wherein the suction nozzle is part of a multi-lumen arrangement of water and/or air supply tubes.

17. A suction device as claimed in claim 1, characterised by the inclusion of an applicator.

18. A suction device as claimed in claim 17, charaterised in that the applicator comprises a rubber dam clamp applicator.

19. A dental suction device for use in a dental operation on a patient, the suction device comprising a clamp for a detachable attachment of the device by a clamping operation to the patient and such as to provide for the self-support of the device, and further comprising securing means for securing a separate suction nozzle to the device, the securing means being firmly attached to the clamp.
